(19) United States
(12) Patent Application Publication
(10) Pub. No.: US 2003/0143984 A1
(43) Pub. Date: Jul. 31, 2003

(54) Remote-controlled system, remote-control method

(75) Inventor: Shigeyuki Umeda, Tachikawa-shi (JP)

Correspondence Address: Finnegan, Henderson, Farabow,, Garret & Dunner, L.L.P., 1300 I Street, N.W., Washington, DC, 20005-3315, US

(73) Assignee: KABUSHIKI KAISHA TOSHIBA

(21) Appl. No.: 10/327,988

(22) Filed: Dec. 26, 2002

(30) Foreign Application Priority Data
Jan. 30, 2002 (JP) 2002-022182

(51) Int. Cl. H04M 3/42

(52) U.S. Cl. 455/414; 455/418

(57) ABSTRACT

A remote-reservation apparatus, which is a remote-controlled one, receives reservations command for recording broadcast TV programs, from mobile telephones via the Internet. The apparatus generates reservation tables for the mobile telephones, respectively. When accessed by any mobile telephone, the remote-reservation apparatus identifies this mobile telephone and stores the reservation data transmitted from the mobile telephone, into the reservation table for the mobile telephone identified.

### CROSS-REFERENCE TO RELATED APPLICATIONS

This application is based upon and claims the benefit of priority from the prior Japanese Patent Application No. 2002-022182, filed Jan. 30, 2002, the entire contents of which are incorporated herein by reference.

### BACKGROUND OF THE INVENTION

1. Field of the Invention

The present invention relates to a system that is remote-controlled via, for example, the Internet, to reserve, for example, the recording of broadcast TV programs and to a method of remote-controlling the remote-controlled system. More particularly, the invention relates to a remote-controlled system and a remote-control method that enable any user to reserve, for example, the recording of broadcast TV programs, not interfered with the reservation data transmitted to the system from any other users.

2. Description of the Related Art

Most household electric apparatuses, such as TV receivers and videocassette recorders, can be remote-controlled by signals transmitted from distant places. Generally, such electric apparatuses have each a controller that can be remote-controlled by the user. The apparatuses must be remote-controlled by operating the remote controllers having ID numbers assigned to them, respectively, in order to avoid errors in remote-controlling them, even if they are of the same type. To remote-control such an apparatus, the user must operate the remote controller assigned to the apparatus, not any other remote controller.

A wireless remote-control system has been proposed in, for example, Jpn. Pat. Appln. KOKAI Publication No. 10-210574. In this system, one remote controller controls a plurality of apparatuses. Conversely, one apparatus may be controlled by selected n remote controllers whose ID numbers have been registered in the apparatus, and specific control items are set at each remote controller.

A videocassette recorder is a household apparatus that is used by some persons, for example, all family members. Recently, videodisk recorders have come into use, now taking place of videocassette recorders. With any videodisk recorder, the users need not replace the recording media need with new ones. If each user has a remote controller for his or her own to control a video disk recorder, it would be more convenient for all users.

Nonetheless, each user cannot feel as if he or she occupied the videodisk recorder. Indeed, each user may operate his or her own remote controller to control the videocassette recorder. However, any user is interfered with the reservation data that input by any other user.

More specifically, Mr. A may operate the first remote controller to reserve the recording of TV program X, and Mr. B may operate the second remote controller to reserve the recording of TV program Y. In this case, the reservation data items about both TV programs X and Y are displayed on both Mr. A's remote controller and Mr. B's remote controller. Hence, Mr. A cannot feel as if the recording of program X only had been reserved in the videodisk recorder. Nor can Mr. B feel as if the recording of program Y only had been reserved in the videodisk recorder.

In the remote-control system disclosed in Jpn. Pat. Appln. KOKAI Publication No. 10-210574, one apparatus can be controlled by Mr. A's remote controller and Mr. B's remote controller, and a specific control item can be set at each remote controller. However, the control items, Mr. A and Mr. B cannot feel as if they occupied the apparatus.

### BRIEF SUMMARY OF THE INVENTION

The present invention has been made in view of the foregoing. An embodiment of the invention is to provide a remote-controlled system and a remote-control method enable any user to reserve, for example, the recording of broadcast TV programs.

To attain the embodiment, according to an aspect of the invention there is provided a system to be controlled by a control signal transmitted from a remote controller, the system comprising: a controller-identifying unit configured to identify remote controllers; and a control unit configured to control the system, in units of the remote controllers, in accordance with a control signal transmitted from any one of the remote controllers identified by the controller-identifying unit.

According to another aspect of the invention, there is provided An apparatus comprising: a receiving unit configured to receive reservation command for recording programs, from data-processing apparatus located at a remote site and connected to the apparatus by a network; an apparatus-identifying unit configured to identify the data-processing apparatus; and a control unit configured to set and manage reservation data for the data-processing apparatus, in accordance with the reservation command transmitted from the data-processing apparatus identified by the apparatus-identifying unit.

According to another aspect of the invention, there is provided a method of controlling apparatus in accordance with a control signal transmitted from a remote controller, the method comprising: identifying remote controllers; and controlling the apparatus, in units of the remote controllers, in accordance with a control signal transmitted from any one of the remote controllers identified.

According to another aspect of the invention, there is provided a method of receiving reservations command for recording programs, from data-processing apparatus located at a remote site and connected to the remote-reservation apparatus by a network, the method comprising: identifying a data-processing apparatus; and setting and managing reservation data for the data-processing apparatus, in accordance with the reservation command transmitted from the data-processing apparatus identified.

In the embodiments of this invention, any remote controller transmits an ID data to the remote-controlled system, which identifies the remote controller based on the ID data and is controlled by the remote controller. Thus, the remote controllers can control the remote-controlled system independently of one another.

The remote-controlled system may be a videocassette recorder. In this case, users can remote-control the reserve the recording of desired TV programs, each feeling feel as if the recording of the TV program only had been reserved in the video disk recorder.

Additional embodiments and advantages of the invention will be set forth in the description which follows, and in part will be obvious from the description, or may be learned by practice of the invention. The features and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic representation of a remote-reservation apparatus according to an embodiment of the invention, which is designed to reserve video recording in accordance with reservation data transmitted from mobile telephones;

FIG. 2 is a diagram illustrating a configuration of reservation data that is stored in the storage unit of the apparatus shown in FIG. 1; and

FIG. 3 is a flowchart explaining a sequence of steps that the apparatus of FIG. 1 performs to accept a remote-reservation for video recording.

### DETAILED DESCRIPTION OF THE INVENTION

An embodiment of the present invention will be described, with reference to the accompanying drawings.

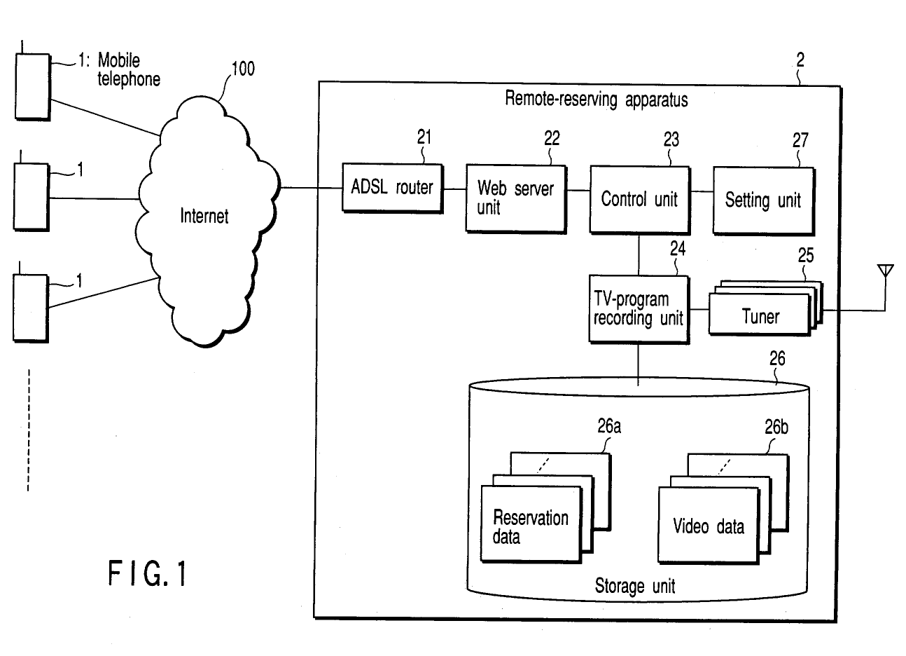

FIG. 1 shows a remote-reservation apparatus 2 that reserves video recording in accordance with the reservation data transmitted from mobile telephones 1.

As FIG. 1 depicts, the remote-reservation apparatus 2 is connected to the Internet 100 by an asymmetric digital subscriber line (ADSL). It can receive video-recording reservation data from a plurality of mobile telephones 1 via the Internet 100.

The apparatus 2 comprises an ADSL router 21, a Web server unit 22, a control unit 23, a TV-program recording unit 24, tuners 25, a storage unit 26, and a setting unit 27.

The ADSL router 21 is a relay device that transmits data via the Internet 100 to the mobile telephones 1 and receives data from the mobile telephones 1 via the Internet 100. The Web server unit 22 functions as an interface through which the user of any mobile telephone 1 can make a reservation for video recording in the remote-reservation apparatus 2. The Web server unit 22 holds HTML documents known as “homepages”. The homepages are document files of hypertext format. The homepages can be accessed when the user operates his or her mobile telephone 1 and thereby designates the uniform resource locator (URL) that is allocated to the remote-reservation apparatus 2. The browser provided in the telephone 1 interprets the homepage thus accessed so that the display of the mobile telephone 1 may display the homepage.

The control unit 23 controls some of the other components of the remote-reservation apparatus 2. The user of any mobile telephone 1 may operate the telephone 1 to reserve the video recording of a desired TV program. When so operated, the telephone 1 generates a reservation command. The reservation command is transmitted to the Internet 100 and thence to the remote-reservation apparatus 2. In the apparatus 2, the control unit 23 controls the TV-program recording unit 24 in accordance with the reservation command.

Controlled by the control unit 23, the TV-program recording unit 24 receives and records the TV program in accordance with the reservation command, without being interfered with the reservation commands made by any other mobile telephone user. Therefore, the remote-reservation apparatus 2 enables two or more mobile telephone users to reserve video recording, each independently of any other user, as will be described later in detail.

The remote-reservation apparatus 2 has n tuners 25, each for selecting and receiving a desired one of the electric waves transmitted from TV broadcast stations. Having n tuners 25, the apparatus 2 can reserve the video recording of n TV programs that will be broadcast on different channels in the same time bracket.

The storage unit 26 is, for example, a hard disk drive that has recording media. The storage unit 26 can store reservation data items 26a and TV program data items 26b. Note that the data items 26a correspond to the reservation commands input by the mobile telephone users and transmitted from the mobile telephones 1.

When operated, the setting unit 27 sets various conditions in which the remote-reservation apparatus 2 should operate. The user of the apparatus 2 may operate the setting unit 27 to register, for example, the ID codes of the mobile telephones 1 that the users may operate to reserve the video recording of TV programs.

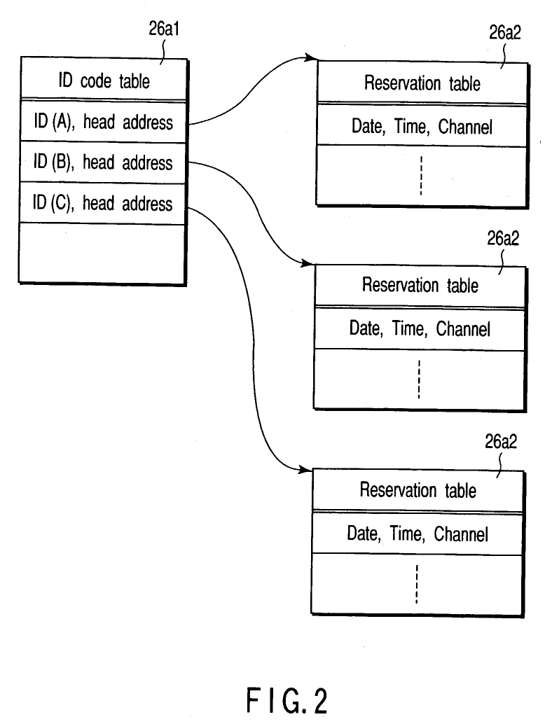

FIG. 2 illustrates the configuration of the reservation data stored in the storage unit 26. As FIG. 2 shows, the reservation data 26a comprises one ID code table 26a1 and reservation tables 26a2. The reservation tables 26a2 are provided in the same number as mobile telephones 1 that can access the apparatus 2 to reserve video recording of TV programs.

The ID code table 26a1 contains ID codes and head addresses. The ID codes are assigned to the mobile telephones 1 that can access the remote-reservation apparatus 2. The head addresses represent the storage areas provided in the reservation table 26a2 and associated with the mobile telephones 1 that can access the apparatus 2.

Each reservation table 26a2 can hold reservation data items as many as reserved TV programs to be recorded. Each reservation data item represents the date, time, channel and the like that designate a TV program that should be recorded in the apparatus 2. It should be noted that the reservation tables 26a2 are provided in the same number as the mobile telephones 1 that can access the apparatus 2 to reserve video recording. Each reservation table 26a2 contains head addresses that represent the storage areas in which TV program data items 26b reserved are stored.

One of the users of the apparatus 2 is entitled to operate the setting unit 27 to register, in the ID code table 26a1, the ID codes assigned to the mobile telephones 1 that can access the remote-reservation apparatus 2. Once the ID codes are registered, thus setting one operating condition of the apparatus 2, the TV-program recording unit 24 generates reservation tables 26a2 for the users of the remote-reservation apparatus 2. The unit 24 records the head addresses representing the storage areas of the reservation tables 26a2.

How the remote-reservation apparatus 2 operates to reserve the video recording of desired TV programs will be explained.

Assume that a mobile telephone 1 is operated and accesses the remote-reservation apparatus 2. Then, the browser provided in the telephone 1 displays the homepage of the Web server 22. The telephone 1 may be further operated, inputting a reservation command on the homepage displayed and thus reserving the video recording of a TV program. The reservation command is transmitted to the remote-reservation apparatus 2, along with the ID code of the telephone 1. In the apparatus 2, the Web server 22 receives both the reservation command and the ID code. The ID code is transferred via the control unit 23 to the TV-program recording unit 24. The TV-program recording unit 24 determines whether the ID code has been registered in the ID code table 26a1.

If the ID code has not been registered, the TV-program recording unit 24 sends a signal to the control unit 23. The signal indicates that the unit 24 does not accept the reservation command. Upon receipt of this signal, the control unit 23 causes the Web server 22 to transmit page data to the mobile telephone 1. The page data shows that the reservation command has been rejected.

If the ID code has been registered, the TV-program recording unit 24 refers to the reservation table 26a2 for the user of the mobile telephone 1. The TV-program recording unit 24 then acquires the reservation data from the reservation table 26a2 and transfers it to the control unit 23. The control unit 23 generates page data from the reservation data item. This page data represents a reservation window showing the date, time, channel and the like that designate the TV program reserved. The page data is transmitted from the Web server 22 to the mobile telephone 1.

The display of the mobile telephone 1 displays the reservation window. The user operates the telephone 1, editing the reservation window and designating an additional TV program or programs. The data representing the reservation window thus edited is transmitted to the remote-reservation apparatus 2 via the Internet 100. In the apparatus 2, the TV-program recording unit 24 receives the data, which is supplied to the storage unit 26. In the storage unit 26, the contents of the reservation window edited are stored in the reservation table 26a2 provided for the user.

Every time the user operates his or her mobile telephone 1, editing the reservation window, the control unit 23 receives the data representing the window edited. The contents of the window are stored in the reservation table 26a2. When the user operates the telephone 1, generating a reservation-end signal. This signal is transmitted to the remote-reservation apparatus 2. Upon receipt of the reservation-end signal, the control unit 23 stops operating to reserve video recording for the user. Thereafter, the control unit 23 waits for a reservation command that may be transmitted from any other mobile telephone 1. Hence, the remote-reservation apparatus 2 rejects a reservation command transmitted from any other mobile telephone 1 until it receives a reservation-end signal from a mobile telephone 1.

As specified above, the ID codes of the mobile telephones 1 are registered in the remote-reservation apparatus 2. Any mobile telephone 1 whose ID code is registered can be used to reserve video recording. By contrast, any mobile telephone whose ID code is not registered cannot reserve video recording, even if operated by the user. Further, the apparatus 2 has reservation tables 26a2, each storing an ID code registered. The reservation data items for the mobile telephones 1 are stored in the reservation tables 26a2 and controlled in accordance with the ID codes, respectively.

Hence, the user of any mobile telephones 1 can reserve video recording, not interfered with the reservation data item that the users of any other mobile telephones 1 have input into the apparatus 2. Thus, the user of each mobile telephone 1 can feel as if he or she occupied the remote-reservation apparatus 2.

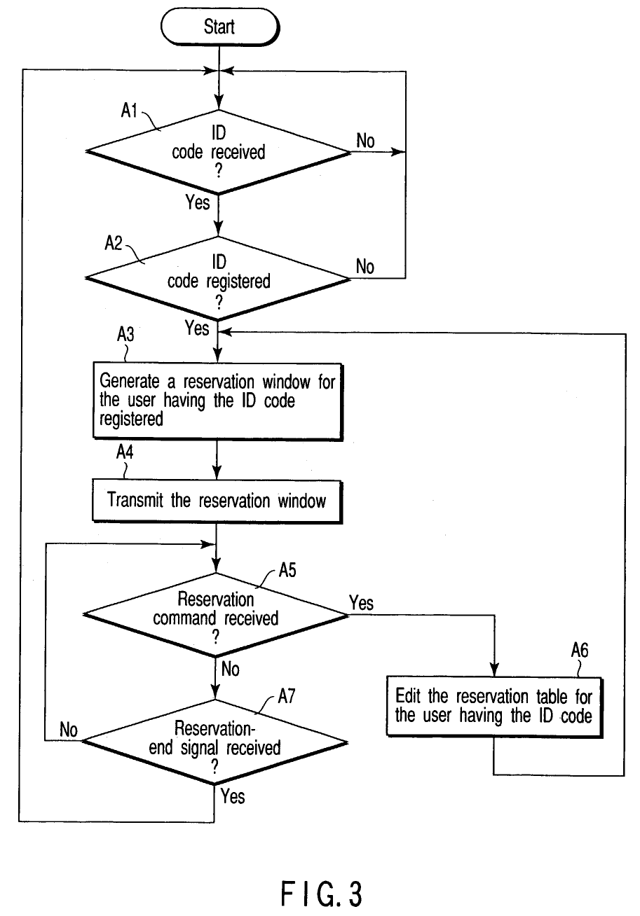

FIG. 3 is a flowchart explaining a sequence of steps that the remote-reservation apparatus 2 performs to accept a remote-reservation for video recording.

First, the apparatus 2 determines whether it as received the ID code from a mobile telephone 1 (Step A1). If YES, the TV-program recording unit 24 determines whether the ID code has been registered or not (Step A2). If NO at Step A2, the unit 24 rejects the reservation command transmitted from the mobile telephone 1.

If the ID code has been registered, or if YES at Step A2, the TV-program recording unit 24 acquires the reservation data the user has input into the mobile telephone 1 and supplies this data to the control unit 23. The control unit 23 generates a reservation window from the reservation data (Step A3). The reservation window thus generated is transmitted to the mobile telephone 1 (Step A4).

Thereafter, TV-program recording unit 24 determines whether data indicating that the reservation window has been edited at the mobile telephone 1 has been edited has transmitted to it (Step A5). If YES at Step A5, the unit 24 writes the contents of this reservation window into the reservation table 26a2 (Step A6). If NO at Step A5, the control unit 23 determines whether the telephone 1 has transmitted a reservation-end signal to it (Step A7). If YES at Step A7, the control unit 23 stops operating to reserve video recording for the user of the mobile telephone 1. If NO at Step A7, the process returns to Step A5.

Thus operating, the remote-reservation apparatus 2 enables the user of any mobile telephone 1 to reserve video recording, not interfered with the reservation data items input into the apparatus 2 from any other mobile telephone 1. Thus, the user of each mobile telephone 1 can feel as if he or she occupied the remote-reservation apparatus 2.

The ID codes of the mobile telephones 1 are the numbers assigned to the telephones 1 in the embodiment described above. Nonetheless, if the mobile telephones 1 are connected to the remote-reservation apparatus 2 by a wireless LAN (Local Area Network), their ID codes will be MAC addresses that are assigned to them. In this case, the reservation data items for the mobile telephones 1 stored in the reservation tables 26a2 are controlled in accordance with the MAC addresses, respectively.

The remote-reservation apparatus 2 has reservation tables 26a2 for the mobile telephones 1, respectively. The reservation tables 26a2 store the reservation data items for the mobile telephones 1. The apparatus 2 may have, in addition to the reservation tables 26a2, a shared reservation table that can store the reservation data item for any mobile telephone 1.

The apparatus 2 described above is designed to reserve the video recording of TV programs. The present invention is not limited to the apparatus 2, however. The invention may be applied to any remote-controlled apparatus that users can control by operating a remote controller, not interfered with the control data other users have generated by operating their remote controllers.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A system to be controlled by a control signal transmitted from a remote controller, said system comprising:
a controller-identifying unit configured to identify remote controllers; and
a control unit configured to control the system, in units of the remote controllers, in accordance with a control signal transmitted from any one of the remote controllers identified by the controller-identifying unit.

2. The system according to claim 1, wherein the control unit including a rejecting unit configured to reject a control signal transmitted from any remote controller, while processing the control signal transmitted from any other remote controller.

3. An apparatus comprising:
a receiving unit configured to receive reservation command for recording programs, from data-processing apparatus located at a remote site and connected to the apparatus by a network;
an apparatus-identifying unit configured to identify the data-processing apparatus; and
a control unit configured to set and manage reservation data for the data-processing apparatus, in accordance with the reservation command transmitted from the data-processing apparatus identified by the apparatus-identifying unit.

4. The apparatus according to claim 3, wherein the control unit including a rejecting unit configured to reject a reservation command transmitted from any data-processing apparatus, while processing the control signal transmitted from any other data-processing apparatus.

5. The apparatus according to claim 3, wherein the control unit including a managing unit configured to manage the reservation data shared by the data-processing apparatus.

6. The apparatus according to claim 3, wherein the reservation data comprises one ID code table and reservation tables in the same number as the data-processing apparatus,
the ID code table contains ID codes assigned the data-processing apparatus and head addresses represent the storage areas provided in the reservation table, and
the reservation table holds reservation data as many as reserved programs to be recorded.

7. A method of controlling apparatus in accordance with a control signal transmitted from a remote controller, said method comprising:
identifying remote controllers; and
controlling the apparatus, in units of the remote controllers, in accordance with a control signal transmitted from any one of the remote controllers identified.

8. A method of receiving reservations command for recording programs, from data-processing apparatus located at a remote site and connected to the remote-reservation apparatus by a network, said method comprising:
identifying a data-processing apparatus; and
setting and managing reservation data for the data-processing apparatus, in accordance with the reservation command transmitted from the data-processing apparatus identified.

9. The method according to claim 8, further comprising:
generating a reservation window for an user using the data-processing apparatus; and
transmitting the reservation window to the data-processing apparatus.

10. The method according to claim 8, further comprising:
determining whether the reservation command transmitted from the data-processing apparatus is received; and
editing the reservation data based on the reservation command when the reservation command is received.
